(19) United States
(12) Patent Application Publication
(10) Pub. No.: US 2017/0242527 A1
(43) Pub. Date: Aug. 24, 2017

(54) SYSTEM AND METHOD FOR DETECTING TOUCH ON A SURFACE OF A TOUCH SENSITIVE DEVICE

(71) Applicant: Knowles Electronics, LLC, Itasca, IL (US)

(72) Inventors: Sarmad Qutub, Des Plaines, IL (US); Asad Ali, Mountain View, CA (US); Stephen Cradock, Itasca, IL (US); Shandor Dektor, Palo Alto, CA (US); Martin Volk, Willowbrook, IL (US); Max Hamel, Barrington, IL (US)

(21) Appl. No.: 15/382,591

(22) Filed: Dec. 16, 2016

Related U.S. Application Data
(60) Provisional application No. 62/296,919, filed on Feb. 18, 2016.

(51) Int. Cl. G06F 3/041; G06F 3/043; G06F 3/044

(52) U.S. Cl. CPC G06F 3/0416; G06F 3/044; G06F 3/043

(57) ABSTRACT

A touch sensitive device including a front panel having a touch surface and a back surface opposite the touch surface. The touch sensitive device further includes one or more vibration transducers mounted to the back surface, and a controller electronically connected to the vibration transducer. The controller receives, from the vibration transducer, a vibration signal, extracts feature information corresponding to predetermined features from the vibration signal, determines, based on the feature information, that a touch occurred within a predefined area of the touch surface, and outputs a signal indicating that the touch occurred within the predefined area of the touch surface.

### CROSS-REFERENCE TO RELATED APPLICATIONS

The present application claims priority to U.S. Provisional Appln. No. 62/296,919 filed Feb. 18, 2016, the contents of which are incorporated herein in their entirety.

### BACKGROUND

Touch sensitive devices can use sensors to determine that a touch has occurred on a surface of the device. Present day touch sensitive devices are mainly limited to non-conductive surfaces due to the way they must operate.

### SUMMARY

In an embodiment, a touch sensitive device including a front panel having a touch surface and a back surface opposite the touch surface. The touch sensitive device further includes one or more vibration transducers mounted to the back surface, and a controller electronically connected to the vibration transducer. The controller receives, from the vibration transducer, a vibration signal, extracts feature information corresponding to predetermined features from the vibration signal, determines, based on the feature information, that a touch occurred within a predefined area of the touch surface, and outputs a signal indicating that the touch occurred within the predefined area of the touch surface.

In an embodiment, a method for detecting touch by a controller includes receiving, from one or more vibration transducers of a touch sensitive device, a vibration signal; extracting feature information from the vibration signal, the feature information corresponding to predetermined features; determining, based on the feature information, that a touch has occurred within a predefined area on a touch surface of the touch sensitive device; and outputting a signal indicating that the touch occurred within the predefined area.

### BRIEF DESCRIPTION OF THE DRAWINGS

The foregoing and other features of the present disclosure will become more fully apparent from the following description and appended claims, taken in conjunction with the accompanying drawings. Understanding that these drawings depict embodiments in accordance with the disclosure and are, therefore, not to be considered limiting of its scope, the disclosure will be described with additional specificity and detail through use of the accompanying drawings.

FIG. 1 depicts an example of touch detection implemented in a capacitive touch sensitive device.

FIG. 2 shows an example apparatus for processing electrical signals output by vibrational transducers in accordance with various implementations.

FIG. 3 shows a representation of an example operation of a decoder in accordance with various implementations.

FIG. 4 shows an example process for sensing vibrations resulting from a user input in accordance with various implementations.

FIG. 5A depicts an example of an embodiment of a touch sensitive device.

FIG. 5B depicts an example of an embodiment of a touch sensitive device.

FIG. 5C depicts another example of an embodiment of a touch sensitive device.

FIG. 6 depicts an example of an embodiment of a controller for detecting touch.

FIG. 7 depicts an example of an embodiment of a method for detecting a touch event.

FIG. 8 is a graph of signal data for an example device according to an embodiment.

FIG. 9 depicts an example of an embodiment of a touch sensitive device used for testing purposes.

FIG. 10 depicts a performance matrix showing touch detection test results from testing of the touch sensitive device depicted in FIG. 9.

FIG. 11A is a block diagram of an example architecture for processing signals from a plurality of vibrational transducer sensors according to embodiments.

FIG. 11B is a block diagram of another example architecture for processing signals from a plurality of vibrational transducer sensors according to embodiments.

In the following detailed description, reference is made to the accompanying drawings, which form a part hereof. In the drawings, similar symbols identify similar components. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

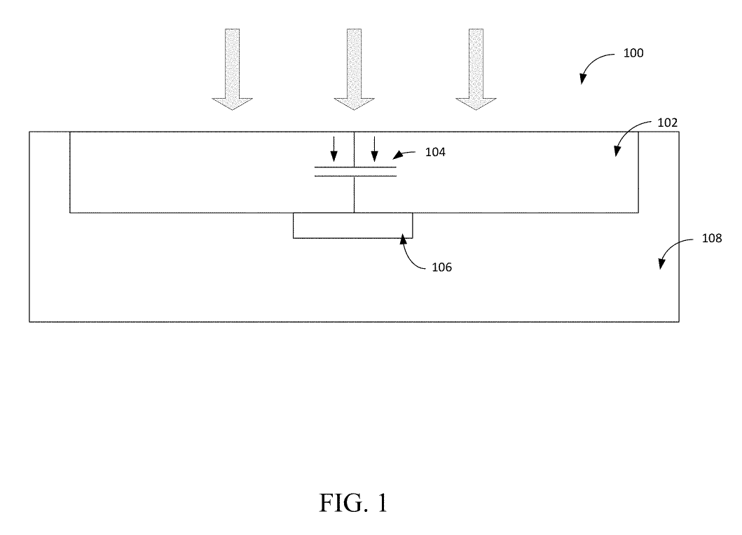

The present disclosure describes systems and methods for detecting touch by a touch sensitive device. Different touch sensitive devices can use different sensors for detecting touch. For example, some touch sensitive devices use capacitors to detect touch. FIG. 1 depicts an example of touch detection implemented by a capacitive touch sensitive device 100. The depicted capacitive touch sensitive device 100 includes a base or frame 108 and touch surface 102 at which a touch may be detected. When a user places a finger adjacent to the touch surface 102, a change in a capacitance 104 of the touch surface 102 may be detected, such as by a sensor 106. The sensor may determine, based on the change in capacitance, that a touch has occurred on the touch surface 102, or may transmit a signal to a controller which makes this determination.

The touch detection described with respect to FIG. 1 is not always suitable for all devices. For example, a gloved or dirty finger may make capacitive sensing inaccurate and/or inconsistent. Additionally, achieving sufficient resolution through capacitive sensing can be expensive. Capacitive sensing may also be ineffective for touch surfaces made from conductive materials, such as metal.

The systems and methods described herein can be used for detecting touch using vibration sensors, and can provide advantages over other types of touch detection. For example, the systems and methods described herein allow for accurate touch detection even with gloved or dirty fingers and can be used for touch detection on devices having surfaces comprised of a conductive material. It should be understood, however, that the systems and methods described are also suitable for touch detection on surfaces comprised of non-conductive materials.

In embodiments of devices and techniques using vibrational sensors for user input, a user interface is incorporated onto a substrate. In one or more embodiments, the substrate includes stainless steel, glass or other rigid or non-rigid materials, and in some embodiments, a substrate including such materials may be used in appliances and other devices. Other materials may additionally or alternatively be used in the substrate. A substrate may include multiple layers of a same or similar material, or multiple layers with one or more of the layers being a material different than the other layers.

Button representations can be provided on a front facing surface of a substrate facing the user, and one or more vibrational sensors can be mounted on a rear surface opposing the front facing surface of the substrate. Pressing on or touching a button representation causes vibrations in the substrate. These vibrations are sensed and measured by the vibrational sensors to identify an intended user input.

Button representations may be provided, for example, by painting, printing, inscribing, lighting or etching the front facing surface of the substrate, or by painting, printing, inscribing, lighting or etching a material which is then attached (e.g., by gluing or laminating) to the front facing surface of the substrate, or a combination thereof. Such a material may be, for example, a film; and the film may be, but is not necessarily, a transparent or translucent film.

Vibrational sensors can be mounted on button areas on the rear surface of the substrate. In some embodiments, the button areas can be defined directly behind corresponding button representations, and one button area can correspond to one button representation. In one or more embodiment, one or more vibrational sensors can be mounted per button area. In some embodiments in which the substrate is multi-layered, one or more of the vibrational sensors may be mounted to a surface of an intermediate layer of the substrate. For convenience, mounting to the rear surface of the substrate is described with respect to the embodiments of the present disclosure; however, it is to be understood that mounting to an intermediate layer of the substrate instead is within the scope of the present disclosure.

In some embodiments, the button representations are omitted, and the vibrational sensors are arranged to detect pressing upon the substrate within a predefined area of the substrate. For convenience, the embodiments described herein are described as having button representations; however, it is to be understood that the button representations may be omitted. Thus, the substrate may not have visible indicators of a button representation for the user interface on the front facing surface of the substrate, though the user interface is available.

Vibrations caused by a user touching a button representation are sensed and measured by the vibrational sensors adjacent to the button area corresponding to the button representation touched by the user, and by other vibrational sensors mounted on other button areas. Electrical signals generated by the vibrational sensors can be processed to identify a valid user input.

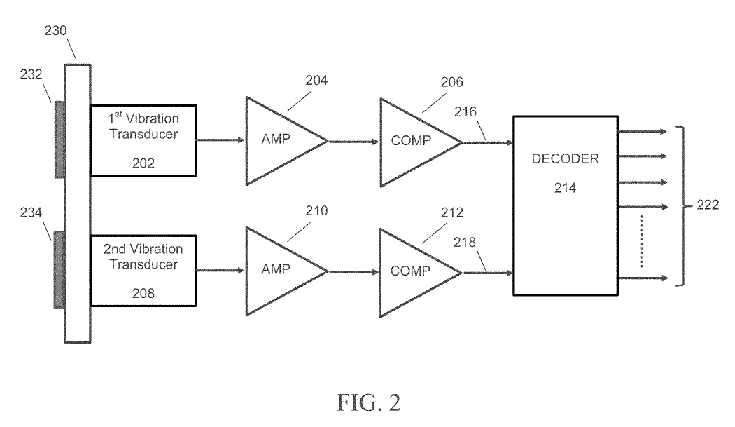

FIG. 2 illustrates a block diagram of an apparatus for sensing a user input. For example, the apparatus 200 can be used to sense a user tap or press on one or more of the button representations on a substrate. Apparatus 200 includes an example touch sensitive interface on a front surface of a substrate 230, a side view of which is shown on FIG. 2. The front surface of the substrate 230 provides button representations 232, 234. As discussed above, one or more of the button representations may be omitted, and the button representations are described with respect to FIG. 2 to aid in an understanding of the concepts of the present disclosure. The substrate 230 may be a generally flat and planar object or structure (such as a plate, panel, platen or a (part of a) screen), although the substrate 230 may exhibit a curvature at one or more edges, at one or more portions of the substrate 230, or generally across an entirety of the substrate 230. In some embodiments, the substrate 230 is used on or in a user interface for a home appliance or consumer electronics device (e.g., a refrigerator, washing machine, oven, cellular phone, tablet, or personal computer). In one or more embodiments, the substrate 230 may be formed of one or more layers of metal (e.g., stainless steel), glass, plastic, or a combination of these materials.

While FIG. 2 shows one embodiment where the front surface of the substrate 230 provides two button representations, it should be understood that in some other embodiments, the front surface of the substrate 230 may include more or less than the number of button representations shown in FIG. 2. Moreover, the shapes of the button representations 232, 234 may be different from the substantially square shape shown in FIG. 2. For example, in one or more embodiments, one or more of the button representations 232, 234 can have substantially circular, elliptical, rectangular, or other polygonal shape, or an irregular shape (e.g., a shape having an arbitrary boundary). In one or more embodiments, the button representations 232, 234 can include labels, such as including one or more numbers and/or letters, arrows, colors, or other visual representations. In addition, the substrate 230 can provide for illumination around or within the button representations (or illumination around or within positions on the front facing surface of the substrate 230 corresponding to button areas on the rear surface of the substrate 230).

A user can press or tap, such as with finger (or fingers) or some other object, the front surface of the substrate 230 over the button representations 232, 234 to enter an input. The user's pressing on the substrate 230 will cause vibrations in the substrate. In one or more embodiments, these vibrations can be sensed by a vibrational sensor. The vibrations may be in any frequency range detectable by the vibrational sensor, such as, for example, infrasonic, acoustic, or ultrasonic.

FIG. 2 further illustrates vibrational sensors comprising vibrational transducers 202, 208 attached to the rear surface of the substrate 230. In one or more embodiments, the vibrational transducers 202, 208 are attached to the side of the substrate that is opposite to the side on which the button representations 232, 234 are provided. For example, the vibrational transducers 202, 208 can correspond to button representations 232, 234, respectively, shown in FIG. 2. In one or more embodiment, more than one vibrational transducer may correspond to each button representation. The vibrational transducers 202, 208 are attached to the substrate 230 by adhesive or any other suitable means. In embodiments, one or both of vibrational transducers 202, 208 are implemented by a strain gauge, an accelerometer, a piezoelectric transducer, a MEMS device (e.g. a MEMS accelerometer or MEMS microphone), or other similar movement or acceleration sensor.

The apparatus 200 shown in the example of FIG. 2 further includes a first amplifier 204, a first comparator 206, a second amplifier 210, a second comparator 212, and a decoder 214. The electrical signals generated by the first vibration transducer 202 and the second vibration transducer 208 are amplified by the first amplifier 204 and the second amplifier 210, respectively. The amplified signals output by the first amplifier 204 and the second amplifier 210 are provided to the first comparator 206 and the second comparator 212, respectively. The first and the second comparators 206 and 212 compare the amplified signals to a predetermined threshold value. Based on whether the received amplified signal is less than or greater than the threshold value, the first and second comparators 206 and 212 provide an appropriate output to the decoder. For example, if the received amplified signals is greater than the threshold value, then a logic high voltage output is provided to the decoder, and if the received amplified signal is less than the threshold value, then a logic low voltage value is provided to the decoder (or vice versa). In one or more embodiments, the threshold values can be predetermined during manufacture or can be set by the user. In one or more embodiments, the threshold value associated with the first comparator 206 can be different from the threshold value associated with the second comparator 212. In one or more embodiments, the threshold values may be permanent, or may be adaptive and change over time, such as to compensate for changes in temperature.

In one or more embodiments, the first vibrational transducer 202 and the second vibrational transducer 208 may output digital outputs instead of analog voltage levels. For example, in one or more embodiments, the first vibrational transducer 202 and the second vibrational transducer 208 may output pulse density modulated (PDM) data or pulse width modulated (PWM) data. In some such embodiments, the digital outputs of the first vibrational transducer 202 and the second vibrational transducer 208 may be provided directly to the decoder 214.

The decoder 214 receives signals originating from the first and second vibrational transducers 202 and 208, and, based on the received signals, determines which ones of the actuation lines 222 to actuate. The actuation lines 222 can represent and control one or more functions. For example, if the apparatus 200 were deployed in a refrigerator, one of the actuation lines 222 may activate a motor, another of the actuation lines 222 may turn on a light, another one of the actuation lines 222 may turn off a light, or increase/decrease temperature. Other example functions are additionally or alternatively possible based on the device in which the apparatus is deployed.

It will be appreciated that the decoder 214 may be any type of processing device such as a microprocessor, controller or the like. For example, the device may execute computer programmed instructions stored in memory to determine which button was touched by the user and assert the appropriate one of the actuation lines 222. In addition, the decoder 214 may be a device that is constructed of discrete or integrated analog components. Combinations of hardware and/or software elements may also be used to implement the decoder 214. In one or more embodiments, the decoder 214 may also include a demodulator to demodulate PDM or PWM data signals received from vibrational transducers that output digital data. In one or more embodiments, the decoder 214 may include additional modules such as one or more sample-and-hold modules, one or more ADCs, or one or more DACs. In one or more embodiments, the decoder 214 may include a timing module that records a time when an input from a vibrational transducer is received. In one or more embodiments, the decoder 214 may sample an analog input, generate a corresponding digital representation, and store the digital representation along with a corresponding time-stamp.

The first amplifier 204, the second amplifier 210, the first comparator 206, the second comparator 212, and the decoder 214 may each be implemented in analog circuitry, in digital circuitry, or in a combination of analog and digital circuitry.

Although shown as discrete devices in FIG. 2, ones of the first amplifier 204, the second amplifier 210, the first comparator 206, the second comparator 212, and the decoder 214 may be integrated together. In some embodiments, integration may be in one or more integrated devices such as a processor, a field programmable gate array, an application specific integrated circuit (ASIC) or other integrated circuit. Further, functionality described with respect to one or more of the first amplifier 204, the second amplifier 210, the first comparator 206, the second comparator 212, and the decoder 214 may be implemented by executing instructions coded in hardware, or by executing instructions stored in a non-transitory memory device (e.g., RAM, ROM, EPROM, EEPROM, MROM, or Flash).

In some embodiments, further analysis may be performed on vibrations that are sensed. For example, in one or more embodiments, vibration patterns from known anomalies in the devices being controlled may be stored (at the decoder or some other processing device) and the sensed vibrations compared to these patterns to detect defects or other types of anomalous situations. For example, if the apparatus 200 is deployed in a refrigerator, the apparatus may sense vibrations and compare these vibrations to vibrational patterns stored in memory, where the stored patterns are from defective compressors. If the sensed patterns match the stored patterns, then a defect is potentially detected. A user can be alerted, for example, by displaying a message on a screen of the refrigerator. It is to be understood that analyses for detecting other types of defects and anomalies are also possible.

In one or more embodiments, the decoder 214 processes the received signals based on parameters such as timing, amplitude, and frequency. For example, in one or more embodiments, the decoder 214 compares a relative timing of the receipt of the various signals at the decoder 214.

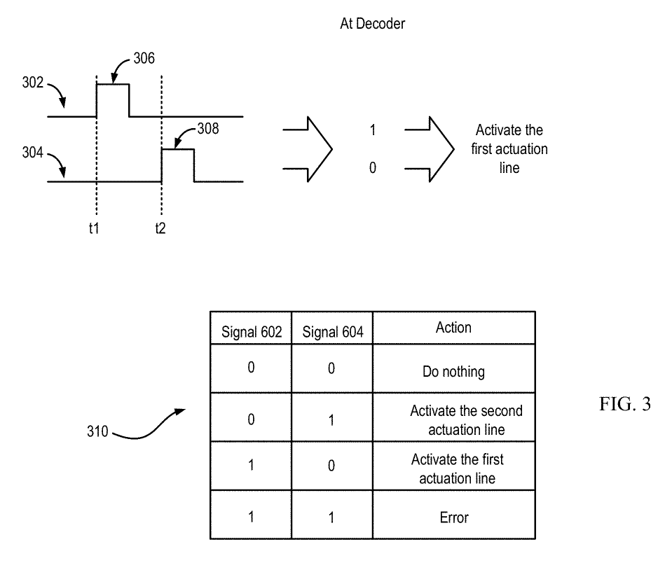

FIG. 3 shows an example operation of the decoder 214 shown in FIG. 2. The decoder 214 receives a first signal 302 and a second signal 304 from the first comparator 206 and the second comparator 212 (FIG. 2), respectively. The first signal 302 goes to logic high 306 at time t1, and the second signal 304 goes to logic high 308 at time t2, which is after time t1. The decoder 214 decodes the signal it receives first as ‘1’ and decodes signals received thereafter (e.g., within a predetermined time period of the designated ‘1’) as ‘0’. Thus, the decoder 214 decodes the first signal 302 going to logic high 306 as a ‘1’ and decodes the second signal 304 going to logic high 308 as a ‘0’. The decoder 214 then accesses a lookup table 310 (stored at the decoder, for example) or a similar data structure that maps the decoded values of the first and second received signals 302 and 304 to a list of actions. In this case, the input matches the third row of the lookup table 310, which indicates that the first actuation line is to be activated. In other embodiments, different decoder 214 functionality is implemented.

As mentioned above, the actuation lines activated by the decoder 214 may perform various functions. For example, they may activate devices (or portions of devices), deactivate devices (or portions of devices), or serve to control operation of another device or electrical or electronic equipment.

While FIGS. 2 and 3 show the apparatus 200 processing signals associated with two vibrational transducers, the apparatus 200 can be readily adapted to receive inputs for more than two vibrational transducers, such as, for example, receiving inputs from an array of vibrational transducers corresponding to an array of button representations on the front surface of substrate 230. In some such embodiments, the decoder can sense a relative timing of each of the received signals going high, and decode the first signal that goes high as ‘1’ and decode the remainder of signals as ‘0’. The lookup table 310 can be similarly modified to include additional columns that correspond to the additional input signals associated with the additional vibrational transducers, and include additional rows that include various combinations of the received inputs and their corresponding actions. Although the example of FIG. 3 is described with respect to identifying logic highs 306 and 308, in other embodiments, logic lows are identified, or transitions between logic low and logic high or logic high and logic low are identified. The terms “logic high” and “logic low” refer to levels associated with a particular implementation. For example, logic high may be greater than approximately 4.8 volts (V), greater than approximately 2.6 V, greater than approximately 1.8 V, greater than approximately 0.8 V, or other relatively high value for the system; and logic low may be a value such as less than approximately 0.2 V, less than approximately 0.08 V, less than approximately 0.02 V, or other relatively low value for the system. For another example, logic high and logic low may be defined relative to the threshold voltage, such as a greater than a predefined first percentage or amount above the threshold voltage for logic high and a less than a predefined second percentage or amount below the threshold voltage for logic low. In some embodiments, instead of voltage, current may be detected.

In one or more embodiments, the decoder may measure the relative amplitudes or the relative frequencies of the received signals instead of the relative timing of when the signals go to a logic high (or a logic low, or make a transition), and determine the decoded inputs and the corresponding actions from the relative amplitudes or relative frequencies.

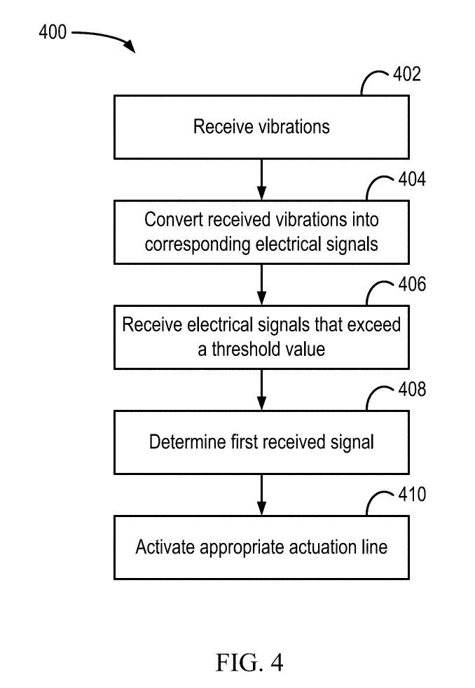

FIG. 4 shows an example process 400 for sensing vibrations resulting from user input. The process 400 includes receiving vibrations (stage 402), converting received vibrations into corresponding electrical signals (stage 404), determining electrical signals that exceed a threshold value (stage 406), determining the first received signal (stage 408), and activating the appropriate actuation line (stage 410). The process 400 can, in part, be representative of the operation of the apparatus 200 shown in FIG. 2.

The process 400 includes receiving vibrations (stage 402) and converting received vibrations into corresponding electrical signals (stage 404). Examples of these process stages have been discussed above in relation to FIGS. 2 and 3. For example, the substrate 230 includes several button representations 232, 234 on which the user can touch or tap to register an input. Vibration transducer 202 (by way of example) can generate an electrical signal that is representative of the sensed vibrations caused by the user tapping or touching the surface of the substrate 230.

The process 400 also includes receiving electrical signals that exceed a threshold value (stage 406). One example of this process stage has been discussed above in relation to FIG. 2. For example, the electrical signals output by the first vibrational transducer 202 are amplified and fed as input to the first comparator 206; the first comparator 206 compares the amplified electrical signals from the first vibrational transducer 202 to a threshold value; if the received amplified signals are greater than the threshold value, the first comparator 206 outputs a high signal, which is received by the decoder 214. It should be noted that many alternatives to merely comparing to a single threshold value are possible.

According to certain aspects, process 400, implemented using only the hardware shown in FIG. 2, can employ a time of arrival scheme. Using this hardware based scheme, decoder 214 only needs to decide on the earliest arrival signal, and the sensor associated with this earliest signal is determined to be the location of tap. This scheme may be used in embodiments where the mechanical mounting of the sensors improves the signal or where there are highly sensitive signals. Accordingly, in these embodiments, the process 400 further includes determining the first received signal (stage 408). One example of this process stage is shown in FIG. 3. For example, the first signal 302 goes to logic high 306 at time t1 prior to the second signal 304 going to logic high 308 at time t2. The decoder compares the times when the received signals go to logic high, and determines that the first signal 302 goes to logic high before the second signal 304. The decoder decodes the first signal going to logic high as a ‘1’ digital value, and decodes the second signal as a ‘0’ digital value.

The process 400 also includes activating the appropriate actuation line (stage 410). One example of this process stage has been discussed above in relation to FIG. 3. For example, the decoder uses the digital values of the received signals (digital value ‘1’ corresponding to the first received signal 302, and the digital value ‘0’ corresponding to the second received signal 304) to access a lookup table 310. The third row of the lookup table 310 matches the digital values of ‘1’ and ‘0’ corresponding to the respective signals 302 and 304, and indicates an action of activating the first actuation line from the set of actuation lines 222 shown in FIG. 2.

Example embodiments of touch sensitive devices incorporating MEMS devices as vibrational sensors will now be described in more detail. As in the previous examples, these embodiments operate by detecting any object contacting and causing vibrations through the front panel of the touch sensitive device. The front panel can be any hard surface material (metal, plastic, or glass). Other, non-rigid surface materials are possible. Contact is detected by using a set (e.g. an array) of two or more small vibration detecting transducers. In one embodiment, these vibration detectors are small accelerometers made from MEMS devices. The MEMS devices provide a small low cost acceleration sensor. These MEMS devices are mounted behind the front panel, thus isolating them from the environment. The present embodiments can be used with gloved hands and are resistant to contaminants that might be encountered in routine use of the device being controlled (dust, dirt, oil, grease, acids, cleansers). By using an array of vibration sensors and detection circuitry, a touch control panel with several buttons can be implemented. By assigning part of the vibration sensor array as background listeners, and the use of appropriate signal processing algorithms the system can accurately locate contact in the presence of background vibrations (i.e. noise). Since the front panel of the touch sensitive device is used as the Human Machine Interface (HMI), the material(s) used for the front panel can be selected to meet the environmental, aesthetic and use requirements of the device.

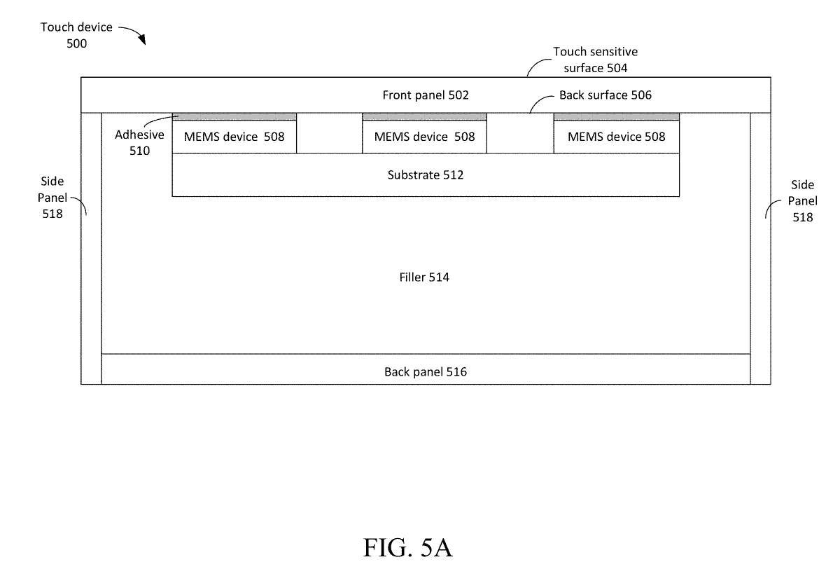

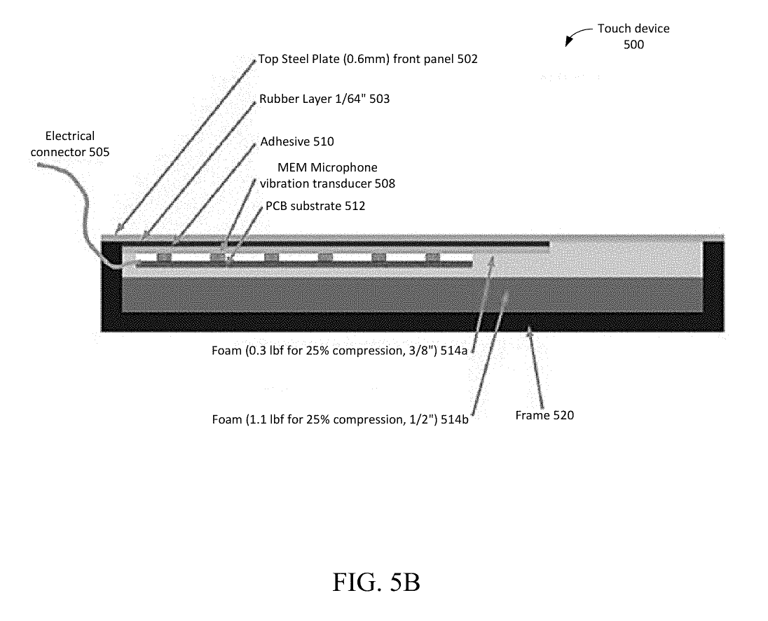

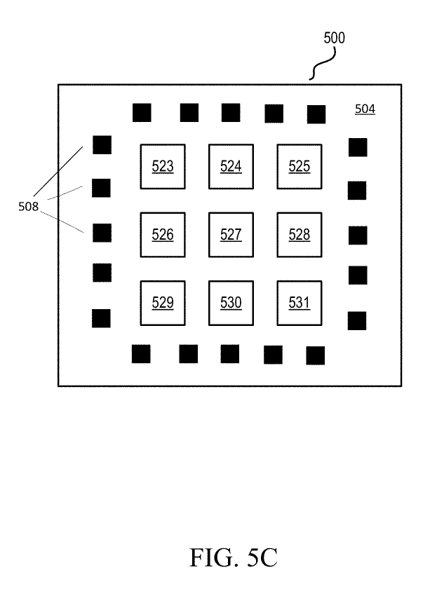

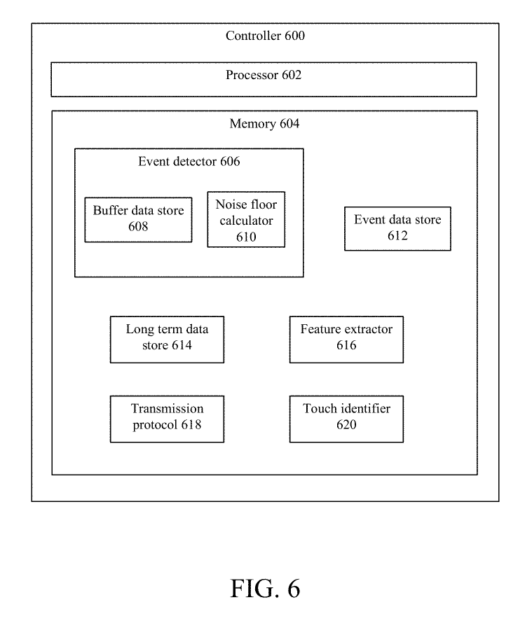

FIG. 5A depicts an example embodiment of a touch sensitive device 500. The touch sensitive device 500 includes a front panel 502, one or more MEMS devices 508, adhesive 510, a substrate 512 (e.g., a printed circuit board (PCB) or a semiconductor substrate), filler 514, a back panel 516, and one or more side panels 518. A controller such as the controller 600 depicted in FIG. 6 can be operably coupled to the MEMS devices 508 (not shown in FIG. 5A). It should be noted that the touch sensitive device 500 corresponds to some embodiments of a touch sensitive device on which the touch sensing systems and methods described herein can be implemented. However, the touch sensing systems and methods described herein can be implemented on other touch sensitive devices as well.

The front panel 502 has a front surface, i.e. touch surface 504 and a back surface 506. At least a portion of the touch surface 504 is exposed such that a user has physical access to the touch surface 504. The front panel 502 can include, for example, metal, ceramic, leather, plastic, glass, acrylic, Plexiglas, composite materials such as carbon fiber or fiberglass, or a combination thereof. In some embodiments, the touch surface 504 includes a covering, such as a plastic or film covering. The touch surface 504 can optionally include button representations to help inform or guide a device user's touch; however, such button representations may be omitted.

The MEMS devices 508 can be any MEMS device that detects vibration. For example, MEMS devices 508 can be MEMS accelerometers. In another example, MEMS devices can be MEMS microphones. In these and other examples, the MEMS microphones can comprise unplugged MEMS microphones, plugged MEMS microphones or MEMS microphones with no ports. Example embodiments of MEMS microphones that can be used to implement MEMS devices 508 are described in more detail in co-pending application No. [K-210PR2], the contents of which are incorporated by reference herein in their entirety.

In one or more embodiments, the MEMS device 508 can be mounted on the front panel 502 (e.g., on the back surface 506) using the adhesive 510. In one or more embodiments, the MEMS device 508 is a MEMS mic mounted such that a sound inlet or port of the MEMS mic is sealed against the back surface 506 of the front panel 502. In other embodiments, the MEMS device 508 is a MEMS mic with the sound inlet or port plugged, and the plugged MEMS mic is mounted against the back surface 506. An adhesive 510 can be applied around a perimeter of the port of the MEMS mic to adhere the MEMS mic to the front panel 502. In one or more embodiments, a two sided adhesive 510 sealant can be used to adhere the MEMS mic to the front panel 502. In some other embodiments, layers of insulating material, such as rubber or plastic, can be applied around the port of the MEMS mic, and adhered to the front panel 502. These and other embodiments are described in more detail in the co-pending application.

The substrate 512 can electrically connect the MEMS devices 508 to a controller 600 (FIG. 6), such as through traces, vias, and other interconnections on or within the substrate 512. In other embodiments, electrical connectors can be used to connect at least one of the MEMS devices 508 to a controller 600. Electrical connectors may be, for example, wires, solder balls, pogo pins, or other electrical connectors. In some embodiments, the substrate 512 can be disposed such that at least one MEMS device 508 is disposed between the substrate 512 and the front panel 502, as depicted in FIG. 5A. For example, the substrate 512 can be connected to a first side of at least one MEMS device 508 that is opposite a second side that is adhered to the front panel 502. In some embodiments, the substrate 512 can be disposed between at least one MEMS device 508 and the touch surface 502. For example, the substrate 512 can be disposed such that a first side of the substrate 512 is adjacent to the back surface 506, and a second side opposite the first side of the substrate 512 is disposed adjacent to the MEMS devices 508.

In one or more embodiments, the filler 514 provides structural support to the substrate 512, the MEMS devices 508, the front panel 502, and/or the controller 600. In some embodiments, the filler 514 can distribute a pressure applied to the filler 514 across the MEMS devices 508 such that the MEMS devices 508 are in contact with the front panel 502. In some embodiments, this can improve an effectiveness of the MEMS devices 508 in detecting vibration. The filler 514 can be any suitable material for providing structural support and/or pressure in the manner described above. For example, the filler 514 can be a foam, a sponge material, a rubber, other material, or a combination thereof. In other embodiments, the touch sensitive device 500 does not include filler 514, and structural support for components can be provided in another appropriate manner, such as, for example, another supporting structure such as a clamp, or by attachment, directly or indirectly, to the back surface 506 of the front panel 502, or to the side panel 518.

In some embodiments, the touch sensitive device 500 includes a frame or body. In an example embodiment, the touch sensitive device 500 includes a body that includes the back panel 516 and the side panels 518. The back panel 516 and the side panels 518, together with the front panel 502, can frame the touch sensitive device 500. The back panel 516 and the side panels 518 can include rigid materials such that other components of the touch sensitive device 500 are shielded from impacts. Non-limiting examples of rigid materials include metal, ceramic, plastic, glass, acrylic, Plexiglas, carbon fiber and fiberglass. The back panel 516 and the side panels 518 can provide structural support for ones of, or all of, the other components of the touch sensitive device 500. In some embodiments, including the embodiment depicted in FIG. 5A, the front panel 502 can cover an entirety of a top surface (in the orientation illustrated) of the touch sensitive device 500. In other embodiments, the side panels 518 can frame the front panel 502 such that front panel 502 does not cover the entirety of the top surface of the touch sensitive device 500. In some embodiments, the back panel 516 and the side panels 518 can comprise one integral frame of the touch sensitive device 500; in other embodiments, the back panel 516 and the side panels 518 are separate pieces, and the side panels can be attached to the back panel 516.

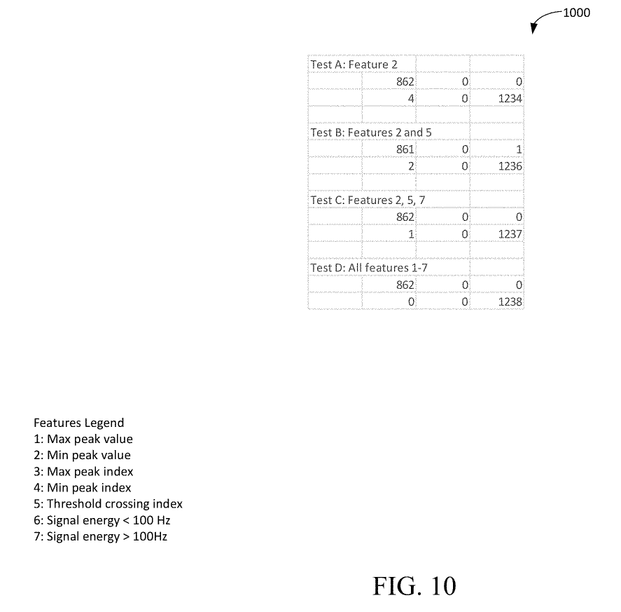

FIG. 5B depicts an example embodiment of the touch sensitive device 500 of FIG. 5A. The example embodiment depicted in FIG. 5B also corresponds to a device used to test the concepts described herein and to produce test data, such as the test data described below in reference to FIG. 10. The example touch sensitive device 500 includes a front panel 502, a rubber layer 503, an electrical connector 505, an adhesive 510, a MEMS device 508, a substrate 512, foam 514a, foam 514b, and a frame 520.

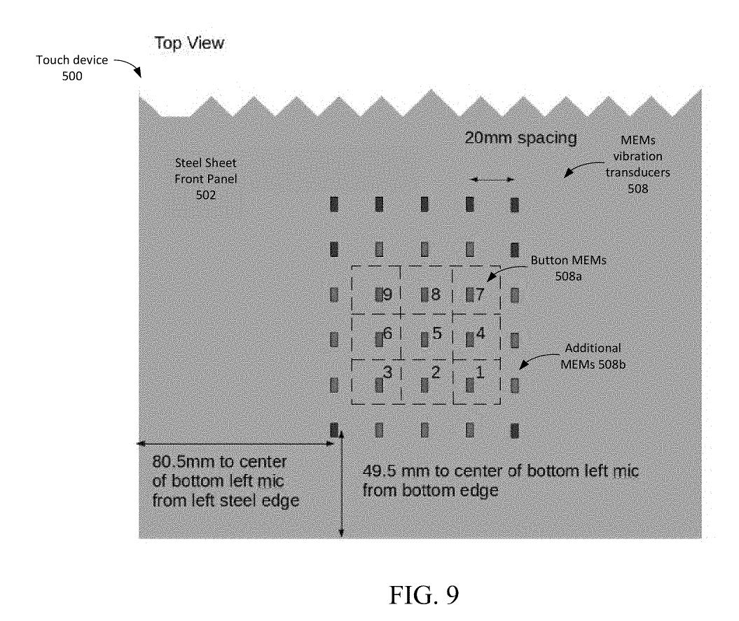

In the example embodiment, the front panel 502 is a steel plate and is approximately 0.6 millimeters (mm) thick. The rubber layer 503 is approximately 1/64″ (inches) thick and is disposed between the front panel 502 and the adhesive 510. The rubber layer 503 is used to cushion a MEMS device 508, and provides a surface well-suited to adhesion by the adhesive 510. The rubber layer can also help to dampen vibrations between microphones. In some other embodiments, the touch sensitive device 500 includes a layer of foam or sponge dampening material. The electrical connector 505 can be any electrical connector, such as a flexible electrical connector, and serves to connect the substrate 512 to an external controller 600 (not shown in FIG. 5B). The adhesive 510, the MEMS device 508, the substrate 512 and the frame 520 are examples of the corresponding components described with respect to FIG. 5A. The foam 514a and the foam 514b are examples of fillers 514. The foam 514a is a foam layer that is approximately ⅜″ thick and compresses by approximately 25% when 0.3 pounds of force is applied to it. The foam 514b is a foam layer that is approximately ½″ thick and compresses by approximately 25% when 1.1 pounds of force is applied to it. Testing was performed on the embodiment of the touch sensitive device 500 depicted in FIG. 5B, as discussed below in reference to FIGS. 9 and 10.

It should be noted that the present embodiments are not limited to vibration sensors mounted on a back surface opposite a touch surface as shown in FIGS. 5A and 5B. For example, FIG. 5C illustrates another example touch sensitive device 500 in which MEMS devices 508 are disposed on a touch surface 504. In this example, the touch surface 504 includes button areas 523-531, and the MEMS devices 508 are arranged in a perimeter around the button areas 523-531 to detect vibrations on the touch surface in response to touches on or near button areas 523-531. It should be noted that the arrangement and relative sizes of MEMS devices 508 and button areas 523-531 are for illustration only and that many variations are possible. For example, the MEMS devices 508 could placed in bezels under or in button areas 523-531. In these and other embodiments, the MEMS devices 508 could be covered with a thin sheet over touch surface 504 so as to be obscured from view.

FIG. 6 depicts an example embodiment of a controller 600. The controller 600 can include one or more executable logics for detecting touch on an area of a touch surface (e.g., touch surface 504 shown in FIG. 5A). The controller 600 can be located within a volume defined by a frame (e.g., similar to the frame 520 illustrated for the device of FIG. 5B, or similar to a frame defined by the back panel 516 and the side panels 518 in the device of FIG. 5A). In other embodiments, the controller 600 can be located external to the frame. In some embodiments, the controller 600 is enveloped by a filler (e.g., the filler 514 in FIG. 5A). The controller 600 can be electronically connected to at least one of the MEMS devices 508 by way of a substrate (e.g., the substrate 512) or other electrical connectors. The controller 600 can be configured to receive vibration signals from at least one of the MEMS devices 508.

In one or more embodiments, the controller 600 includes at least one processor 602 and at least one memory 604. The memory 604 can include one or more digital memory devices, such as RAM, ROM, EPROM, EEPROM, MROM, or Flash memory devices. The processor 602 can be configured to execute instructions stored in the memory 604 to perform one or more operations described herein. The memory 604 can store one or more applications, services, routines, servers, daemons, or other executable logics for detecting touch on the touch surface. The applications, services, routines, servers, daemons, or other executable logics stored in the memory 604 can include any of an event detector 606, an event data store 612, a feature extractor 616, a touch identifier 620, a long term data store 614, and a transmission protocol logic 618.

In one or more embodiments, the event detector 606 can include one or more applications, services, routines, servers, daemons, or other executable logics for determining that a potential touch event has occurred. The event detector 606 can monitor and store signals received from one or more vibration transducers, and can determine when the signals indicate that a potential touch event has occurred. The event detector 606 may include or be coupled to a buffer data store 608 and a noise floor calculator 610.

In one or more embodiments, the event detector 606 can store a vibration signal received from at least one MEMS device 508 frame by frame. For example, the event detector 606 can continuously or repeatedly store the incoming vibration signal in buffer data store 608, and can continuously or repeatedly delete oldest signal data from buffer data store 608 after some time has passed, such as after a predetermined amount of time. In this manner, the event detector 606 can maintain the buffer data store 608 such that only a most recent portion of the vibration signal is stored. For example, the event detector 606 can store only a most recent half second (or another time period) of the vibration signal. This can reduce data storage needs and can allow for efficient use of computer resources.

In one or more embodiments, the event detector 606 can monitor the portion of the vibration signal stored in the buffer data store 608 for an indication that a potential touch event has occurred. For example, the event detector 606 can determine, based on the stored portion of the vibration signal, that the vibration signal or an average or accumulation thereof has crossed a noise floor threshold, or that the vibration signal or average or accumulation thereof is above the noise floor threshold. When the event detector 606 determines that the vibration signal or an average or accumulation thereof is above the noise floor threshold, the event detector 606 can determine that a potential touch event has occurred and can store at least part of the portion of the signal stored in buffer data store 608 in the event data store 612 as a potential event signal, or can associate the at least part of the portion of the signal with a potential event and can store an indicia of that association in the event data store 612. The event detector 606 can set a time at which the vibration signal crossed a noise floor threshold as an event start time. In some embodiments, the event detector 606 can store a portion of a vibration signal as a potential event signal in the event data store 612, the portion of the vibration signal corresponding to a time frame that includes a first amount of time prior to the event start time and a second amount of time after the event start time. For example, when the event detector 606 determines that the vibration signal or an average or accumulation thereof is above the noise floor threshold, or has crossed the noise floor threshold, the event detector 606 can continue to store the vibration signal frame by frame for a predetermined amount of time, such as for an additional half second, and can then store the portion of the vibration signal stored in the buffer data store 608 as a potential event signal in the event data store 612.

In some embodiments, the noise floor threshold is a predetermined threshold. In other embodiments, the noise floor calculator 610 calculates the noise floor threshold based on an adaptive algorithm, such that the noise floor threshold is adaptive to a potentially changing noise floor. For example, the noise floor calculator 610 can calculate a first noise floor at a first time based on a portion of a vibration signal stored in the buffer data store 608 at the first time, and at a second time can calculate a second noise floor based on a portion of a vibration signal stored in the buffer data store 608 at the second time, or based on an accumulation value (e.g., an accumulated average value of the vibration signal). Example techniques for adaptively calculating the noise floor threshold according to these and other embodiments are described in more detail in J. F. Lynch Jr, J. G. Josenhans, R. E. Crochiere, “Speech/Silence Segmentation for Real-Time Coding via Rule Based Adaptive Endpoint Detection.”

In one or more embodiments, when the event detector 606 determines that a potential touch event has occurred and stores the portion of the signal stored in the buffer data store 608 in the event data store 612, the event detector 606 can also store a portion of a second vibration signal that corresponds to second MEMS device 508 in the event data store 612. In some embodiments, the portion of the first vibration signal and the portion of the second vibration signal correspond to a same time frame. The event detector 606 can store vibration signals as potential event signals for any number of signals that correspond to the MEMS devices 508, in any appropriate manner, including in the manner described above. It should be noted that the number of signals stored can depend on a number of factors, such as a storage capacity of buffer data store 608.

The feature extractor 616 can include one or more applications, services, routines, servers, daemons, or other executable logics for extracting features or identifying values corresponding to features from signals or from portions of signals stored in a data store, such as the event data store 612, or any other appropriate data store, such as the buffer data store 608. The features can be predetermined features. For example, the features can include: (i) a maximum signal amplitude, (ii) a minimum signal amplitude, (iii) a time at which a signal achieves a maximum amplitude, (iv) a time at which a signal achieves a minimum amplitude, (v) a time at which a signal amplitude crosses a predetermined amplitude threshold, (vi) an energy contribution to the signal by frequencies equal to or below a first predetermined frequency threshold, and (vii) an energy contribution to the signal by frequencies equal to or above a second predetermined frequency threshold, where the first and second predetermined frequency thresholds can be any appropriate frequency threshold. Without limitation or loss of generality, in some embodiments, the first and/or second predetermined frequency threshold is in a range of 50-150 Hertz (“Hz”). In some embodiments, the first and/or second predetermined frequency threshold is in a range of 90-110 Hz. In some embodiments, the first and/or second predetermined frequency threshold is 100 Hz.

In one or more embodiments, the feature extractor 616 can extract features from two or more signals. For example, the feature extractor 616 can extract features from two signals stored in the event data store 612 that respectively correspond to different respective vibration transducers, and/or that correspond to a same time frame. In some embodiments, a touch sensitive device (e.g., the touch sensitive device 500) can include two or more vibration transducers, the event data store 612 can store a set of two or more signals that respectively correspond to the two or more vibration transducers, and the feature extractor 616 can extract a same set of features from the two or more signals. For example, the feature extractor 616 can extract a minimum amplitude for each of two or more signals stored in the event data store 612.

In some embodiments, the touch identifier 620 can include one or more applications, services, routines, servers, daemons, or other executable logics for determining that a touch event has occurred, and/or for determining at which area of a predefined set of areas of the touch surface the touch event occurred. The touch identifier 620 can determine that a touch event has occurred at an area of the touch surface based on, for example, one or more event signals stored in the event data store 612, and/or based on features extracted by the feature extractor 616. In some embodiments, the touch identifier 620 includes a classifier that can classify extracted features of vibration signals as corresponding to a touch event at an area of the touch surface. The classifier can be, for example, a model that takes features or feature values as inputs, and outputs a determination that a touch event has occurred, or has not occurred, at an area of the touch surface. For example, the feature extractor 616 can extract a minimum amplitude for each of a set of signals stored in the event data store 612, the signals respectively corresponding to different vibration transducers and corresponding to a same time frame. The classifier can output a determination as to whether and where a touch has occurred based on the minimum amplitudes.

A classifier or model of the touch identifier 620 can be generated by a machine learning algorithm trained on annotated training data. For example, the model can be a linear combination of a number of features, and weights for those features can be determined by a machine learning algorithm. Examples of features and classifiers that make use of those features are described in reference to FIG. 10. The output of the classifier can be, for example, a touch score. The training data can be, for example, related to a particular choice of vibration transducer, such as a MEMS mic, or to a composition of a touch surface, such as a steel touch surface. In other embodiments, the training data can be related to other factors. In some embodiments, the training data can correspond to the touch sensitive device (e.g., the touch sensitive device 500). For example, the touch identifier 620 can be trained based on local data, such as data acquired during a calibration of the touch sensitive device. In some embodiments, the training data can be based at least in part on training data related to one or more other touch sensitive devices.

Training can be done either with, or without, being installed in the end device (e.g, oven or other appliance). This can involve collecting “labeled” data by the touch sensitive device and feeding it through the algorithm to train it. Note that it is also possible to have a short training session during production of the end device, essentially to calibrate the touch sensitive device to the end device.

The touch identifier 620 can be used to determine whether a touch event occurred at one area of a predetermined set of areas of the touch surface. For example, at least a portion (not necessarily contiguous) of the touch surface can be divided into two or more designated areas, and the touch identifier 620 can determine which area a touch event corresponds to. In some embodiments, the touch surface includes a single designated area. In some embodiments, the areas can correspond to locations at which one or more vibration transducers are disposed. In some embodiments, the areas can be designated based on button representations on a touch surface (e.g., the touch surface 504).

In one or more embodiments, the touch identifier 620 can be used to determine a touch score for one or more of the areas. The touch score can be, for example, equal to a linear combination of the features. The touch identifier 620 can determine that the area corresponding to the highest touch score is an area at which the touch event occurred. In some embodiments, the touch identifier 620 can determine that a touch event has occurred at multiple areas. For example, the touch identifier 620 can determine that a touch event has occurred at any area corresponding to a touch score above a predetermined threshold. In some embodiments, the touch score can be generated by the classifier or model of the touch identifier 620.

In one or more embodiments, the controller 600 can include or can access, directly or indirectly, the long term data store 614. The controller 600 can receive vibration signal data from at least one of the vibration transducers and can store the vibration signal data in the long term data store 614. In some embodiments, the controller 600 can store vibration signals in the long term data store 614 corresponding to a longer period of time than the vibration signals stored in the buffer data store 608. In some embodiments, the controller 600 can store vibration signals in the long term data store 614 corresponding to data that is deleted by the event detector 606 from the buffer data store 608. In some embodiments, the controller 600 can store vibration signals in parallel to both the long term data store 614 and the buffer data store 608. In some embodiments, the data stored in the long term data store 614 can be used to train or evaluate a machine learning classifier, such as, for example, a machine learning classifier of the touch identifier 620, or a machine learning classifier trained to classify data, including features of vibration signals, as corresponding to touch events. The training can occur locally, remotely, or as some combination of the two.

In some embodiments, the transmission protocol logic 618 can include one or more applications, services, routines, servers, daemons, or other executable logics for transmitting or uploading data stored in the long term data store 614 to a remote data store, such as, for example, a cloud data store. In some embodiments, the controller 600 further includes a transmitter, or can access a transmitter of the touch sensitive device, and the transmission protocol logic 618 can cause the transmitter to transmit data from the long term data store 614 to a remote data store. In some embodiments, the transmission protocol logic 618 can cause the transmitter to transmit the data from the long term data store 614 on a fixed schedule, such as, for example, every hour, every day, every week, every month, or on any other appropriate fixed schedule. In some embodiments, the transmission protocol logic 618 can cause the transmitter to transmit the data from the long term data store 614 responsive to the long term data store 614 storing an amount of data above a threshold. In some embodiments, the threshold is based on an amount of available space or memory available in the long term data store 614. In some embodiments, the controller 600 can delete data stored in the long term data store 614 responsive to the data being transmitted to a remote data store.

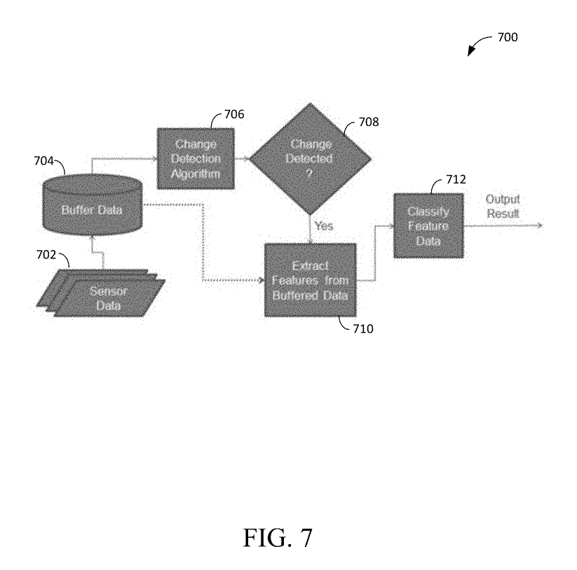

FIG. 7 depicts an example embodiment of a method 700 for detecting a touch event. The method 700 includes blocks 702-712. At block 702 and 704, data may be stored in a buffer data store. For example, signal data can be received by the controller 600 from one or more vibration transducers (e.g., the MEMS devices 508). The signal data can be stored in a buffer data store (e.g., the buffer data store 608). The signal data can be stored in the buffer data store, for example, frame by frame as described above, or in any other appropriate manner.

In one or more embodiments, at blocks 706 and 708, a change detection algorithm can detect that the signal has exhibited a change indicative of a potential touch event. For example, an event detector (e.g., the event detector 606) can determine that signal data stored in the buffer data store corresponds to a potential touch event, based on, for example, the signal crossing a noise floor threshold calculated by a noise floor calculator (e.g., the noise floor calculator 610). Responsive to this determination, the event detector can store at least a portion of the signal data stored in the buffer data store or in the event data store (e.g., the event data store 612).

In one or more embodiments, at block 710, a feature extractor (e.g., the feature extractor 616) can extract features from the signal data stored in the event data store. In other embodiments, the feature extractor can extract features from the signal data stored in the buffer data store. The extracted feature data can correspond to one or more predetermined features.

In one or more embodiments, at block 712, a touch identifier (e.g., the touch identifier 620) can classify the extracted feature data as corresponding to a touch event, or as not corresponding to a touch event. The touch identifier can so classify the extracted feature data using a classifier or model, such as a machine learning classifier, as described above in reference to FIG. 6. The touch identifier can output a signal indicative of the determination that the extracted feature data does or does not correspond to a touch event.

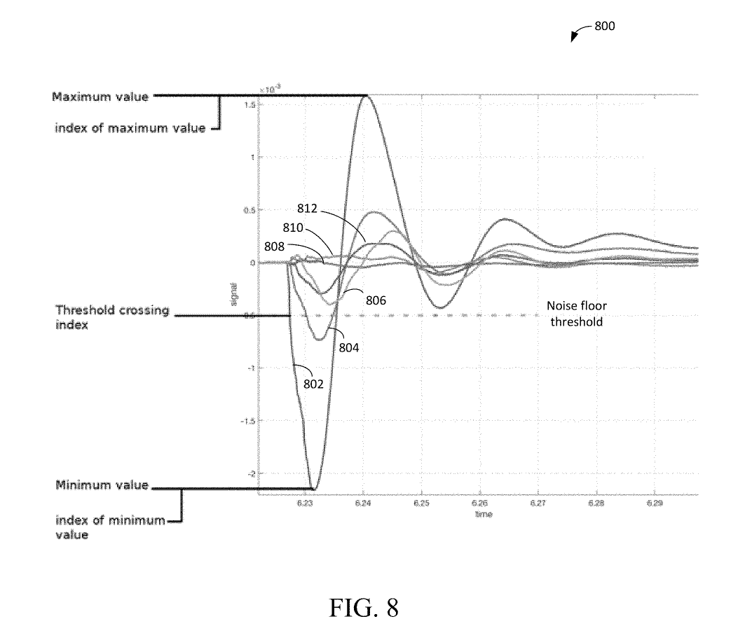

FIG. 8 is a graph 800 including a snapshot of six vibration signals 802, 804, 806, 808, 810, and 812 respectively corresponding to six different vibration transducers (e.g., six of the MEMS devices 508). The snapshot of the vibration signals can represent the signals during a window or time frame that corresponds to signal data stored in a buffer data store (e.g., the buffer data store 608), or in an event data store (e.g., the event data store 612), or in a long term data store (e.g., the long term data store 614), or in any other appropriate data store. The x-axis of the graph indicates time in seconds, and the y-axis of the graph indicates a voltage in millivolts (“mV”) of signals received by a controller (e.g., the controller 600) from the vibration transducers. In other embodiments, the signals may be processed before being received by the controller, and the signal data may be in any other appropriate format. The term “index” as used in various labels on the graph refers to x-axis values (time values) at which events occur. For example, an “index of maximum value” can be a time at which a signal achieves its maximum value, an “index of minimum value” can be a time at which a signal achieves its minimum value, and a “threshold crossing index” can be a time at which a signal crosses a noise floor threshold. Any of these indexes (or time values) can be used as parameters of predetermined features, in at least some embodiments.

In one or more embodiments, a noise floor calculator (e.g., the noise floor calculator 610) can determine a noise floor threshold, such as that a noise floor threshold is 0.5 mV as illustrated in FIG. 8. This can correspond to a predetermined noise floor threshold, or can be calculated adaptively, as described above in reference to FIG. 6. By way of example with respect to FIG. 8, an event detector (e.g., the event detector 606) can analyze signal data stored in the buffer data store, and can determine that the signal 802 crossed the noise floor threshold, indicating that a potential touch event has occurred. The event detector can allow the controller to continue storing signal data in the buffer data store frame by frame for a predetermined amount of time, as discussed above, such as for an additional 0.6-0.7 seconds, and can then store the signal data (e.g., the signal data shown on graph 800) in the buffer data store or in the event data store. In some embodiments, the event detector can determine that a potential touch event has occurred based on a single signal (e.g., signal 802) crossing the noise floor threshold, or based on any one signal or combination of signals crossing the noise floor threshold. In some embodiments, the event detector does not detect a signal crossing the noise floor threshold in real-time, and instead can analyze data stored in a data store of the touch sensitive device to detect that a signal has crossed the noise floor threshold. The event detector can store a snapshot of the signal data over an appropriate time frame in the event data store, such as a time frame that includes the time at which one or more signals crossed the noise floor threshold.

In one or more embodiments, a feature extractor (e.g., the feature extractor 616) can analyze the signal data stored in the event data store to extract features, such as any of the predetermined features described above. In some embodiments, the feature extractor can extract predetermined features from multiple signals, and each extracted feature value for each signal can be used by a touch identifier (e.g., the touch identifier 620) as an independent parameter value for determining whether and where a touch event occurred. As set forth above, the extracted features can include: (i) a maximum signal amplitude, (ii) a minimum signal amplitude, (iii) a time at which a signal achieves a maximum amplitude, (iv) a time at which a signal achieves a minimum amplitude, (v) a time at which a signal amplitude crosses a predetermined event threshold, (vi) an energy contribution to the signal by frequencies equal to or below a first predetermined frequency threshold, and (vii) an energy contribution to the signal by frequencies equal to or above a second predetermined frequency threshold, where the first and second predetermined frequency thresholds can be any appropriate frequency threshold.

FIG. 9 depicts a top view of the example embodiment of the touch sensitive device 500 depicted in FIG. 5B that was also used for testing, which includes a steel sheet as the front panel 502. The depicted MEMS microphones are not actually viewable from a top view of the front panel 502, but are depicted as visible here for descriptive purposes. While FIG. 9 depicts a specific embodiment of the touch sensitive device 500 that correspond to testing that is described below in reference to FIG. 10, other embodiments of the touch sensitive device 500 can differ from the depicted embodiment in many ways, including but not limited to type of MEMS device 508, number of MEMS devices 508, positioning or disposition of MEMS devices 508, and composition or shape of the touch surface 504.

In the example embodiment shown in FIG. 9, the touch sensitive device 500 includes the steel plate front panel 502, button areas 1-9 shown outlined in dotted line, and MEMS devices 508, which include button MEMS microphones 508a and additional MEMS microphones 508b (e.g. “background listeners” or “keep out” sensors). The button areas 1-9 designate detection areas from a user-facing view of the front panel 502. Additionally, not shown, button representations may be provided, for example, by painting, printing, inscribing or etching a front facing, touch surface of the front panel 502, or by painting, printing, inscribing or etching a material which is then attached (e.g., by gluing or laminating) to the front facing surface, or a combination thereof. Such a material may be, for example, a film; and the film may be, but is not necessarily, a transparent or translucent film. The button representations can be used, for example, to guide a person or machine interacting with the front panel 502. The button representations can correspond to the button areas 1-9.

The button MEMS microphones 508a correspond to MEMS microphones disposed behind the front panel 502 at locations that correspond to button areas 1-9. In other embodiments, the button MEMS microphones 508a are MEMS microphones that are closest to respective button areas. The additional MEMS microphones 508b are MEMS microphones that are disposed adjacent to or near the button MEMS microphones 508a. The additional MEMS microphones 508b are similar to the button MEMS microphones 508a, except for their placement. Signals from the button MEMS microphones 508a and from the additional MEMS microphones 508b can be received and used by a controller (e.g., the controller 600) to determine whether and where a touch event has occurred. In the example of FIG. 6, the MEMS devices 508 are spaced approximately 20 mm apart in horizontal spacing, and are disposed in a rectangular grid having edges that are parallel to edges of the front panel 502. In the example of FIG. 9, a MEMS device 508 occupying a corner of the rectangular grid is disposed approximately 49.5 mm from a bottom edge of the front panel 502 and approximately 80.5 mm from a left side edge of the front panel 502.

In other embodiments, the MEMS devices 508 can be disposed or spaced in any appropriate manner, and need not be disposed in an evenly spaced configuration. For example, the disposition of sensors behind the button areas on the front panel is designed to maximize the classification success of the algorithm. While the previously described algorithm can function with any disposition of sensors, it is advantageous in some embodiments to place sensors directly underneath and surrounding the desired touch sensitive area. In this configuration, the “button” sensor (e.g. MEMS microphones 508a) directly underneath the touch sensitive area will record a substantially larger signal relative to the adjacent “keep out” sensors (e.g. MEMS microphones 508b), whereas pressing outside the contact area will result in either larger or comparable in magnitude signals at the adjacent “keep out” sensors, enabling reliable classification.

In general, the number of and spacing of “keep out” sensors is a function of the layout of the touch locations themselves as well as the “resolution” of the touch on the surface. In the case of a dense grid of touch locations, the “keep out” sensors may only be necessary around the perimeter of the array. In the case of sparsely distributed touch locations, each touch location may require 2-3“keep out” sensors to prevent touches outside of the contact area from producing a false classification. The “resolution” characterizes how the measured features of the received signals change as a function of the touch location. A setup with low resolution will require additional sensors to provide sufficient information to the classification algorithm.

FIG. 10 depicts a performance matrix 1000 showing touch detection test results from testing of the touch sensitive device 500 embodiment depicted in FIG. 5B and in FIG. 9. The performance matrix 1000 shows the results of four tests, tests A-D, in which different predetermined features were used by a classifier of a touch identifier. The predetermined features used in the tests were: (i) a maximum signal amplitude (max peak value), (ii) a minimum signal amplitude (min peak value), (iii) a time at which a signal achieves a maximum amplitude (max peak index), (iv) a time at which a signal achieves a minimum amplitude (min peak index), (v) a time at which a signal amplitude crosses a predetermined event threshold of 0.5 mV (threshold crossing index), (vi) an energy contribution to the signal by frequencies equal to or below a predetermined frequency threshold of 100 Hz, and (vii) an energy contribution to the signal by frequencies above a predetermined frequency threshold of 100 Hz. In test A, feature (ii) was used. In test B, features (ii) and (v) were used. In test C, features (ii), (v) and (vii) were used. In test D, features (i), (ii), (iii), (iv), (v), (vi) and (vii) were used.

It should be noted that a frequency threshold of 100 Hz has been found advantageous in many embodiments. In other embodiments, a frequency threshold in the range of 50-150 Hz provides sufficient results, and in other embodiments, a frequency threshold in a range of 0-1000 Hz can be used. Moreover, in still further embodiments, a frequency range is divided up into frequency bins, with a frequency threshold for each.

In the performance matrix 1000, results from each of tests A, B, C, D are shown in a matrix of two rows and three columns of numbers: row 1, column 1 corresponds to a number of correct button classifications (correct identification by a touch identifier that a touch event, such as a finger tap, has occurred, and that the touch event has occurred at a particular area); row 1, column 2 corresponds to a number of incorrect button classifications (correct identification by the touch identifier that a touch event has occurred, but incorrect identification of the area at which the touch event occurred); row 1, column 3 corresponds to a number of missed button classifications (touch events occurred but were not identified as touch events by a touch identifier); row 2, column 1 corresponds to a number of non-events classified as a button tap (false positives where the touch identifier determined that a touch event had occurred, when in fact it had not); row 2, column 2 is always zero, and row 2, column 3 corresponds to a number of non-events correctly classified as non-events. Non-events can include, for example, touch events outside of the button areas or in between button areas, or other types of vibrational input to the touch sensitive device 500 that are not touch events in the button area, such as knocks outside the button areas and shaking of the device. As can be seen from the results, the tests were very successful. For example, in test A, when only feature 2 was used, all 862 touch events were correctly classified as touch events at a correct location, and 1234 out of 1238 non-events were correctly classified as non-events. In test D, when all seven features were used, all 862 touch events were correctly classified as touch events at correct locations, and all 1238 non-events were correctly classified as non-events.

Note that features can be determined for all of the button MEMS microphones 508a and the additional MEMS microphones 508b. Thus, for a number ‘x’ of features and a combined number ‘y’ of sensors (the button MEMS microphones 508a plus the additional MEMS microphones 508b), a number ‘z’ of values used for touch detection can be z=xy.

As can be seen from the performance matrix 1000, the combinations of features tested were each successful in identifying actual touch events and rejecting non-events. Notably, test A was performed using a classifier that used a single feature, feature (ii), minimum signal amplitude (min peak value), illustrating that the systems and techniques of the present disclosure, using vibration transducers, provide for accurate and consistent touch detection.

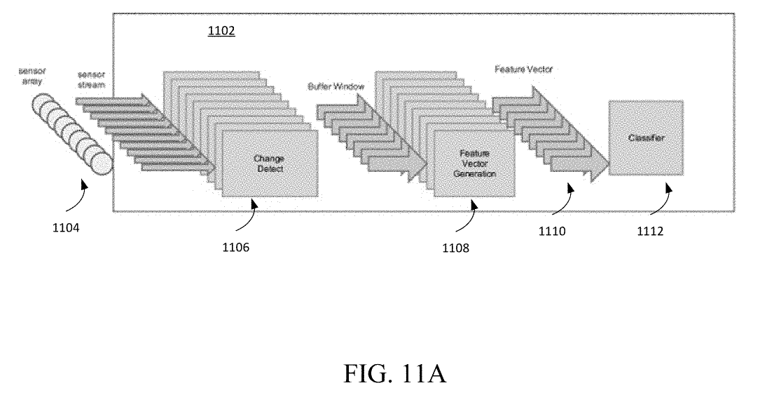

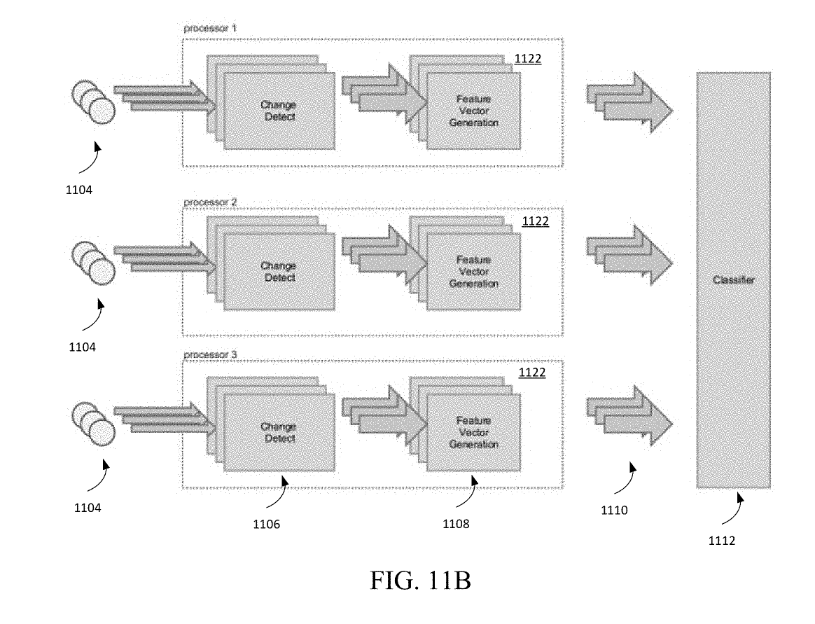

FIGS. 11A and 11B are architectural diagrams illustrating possible examples of how a system including multiple sensors (e.g. for a touch panel having multiple buttons) and associated controller(s) could be implemented according to embodiments.

In the example architecture of FIG. 11A a single processor 1102 processes a stream of signals from multiple sensors 1104 (e.g. an array of MEMs vibration transducers such as 508 shown in FIG. 9). Processor 1102 includes respective instances of change detectors 1106 and feature vector generators 1108 that are running for each sensor, which together form feature vectors 1110 for each sensor that is provided to classifier 1112.

Another example architecture is shown in FIG. 11B in which multiple processors 1122 are each allocated to process signals from one or more sensors 1104. Each of these “sensor processors” 1122 implements instances of change detectors 1106 and feature vector generators 1108 that are running for each sensor that is allocated to the processor. The classifier 1112 receives the feature vectors 1110 from each sensor processor 1122, and may be executed by a separate processor. This separate processor and sensor processors 1122 may further include a software mechanism or communication protocol to ensure that the windows of data for which the feature vectors are calculated are consistent. An advantage of the example architecture of FIG. 11B is that it can be scaled for a large number of tap detection areas.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A touch sensitive device, the device comprising:
a front panel having a first surface and a second surface, the first surface being exposed to touch;
a first vibration transducer mounted to the second surface; and
a controller electronically connected to the first vibration transducer, the controller configured to:
receive, from the first vibration transducer, a first vibration signal;
extract feature information corresponding to predetermined features from the first vibration signal;
determine, based on the feature information, that a touch occurred within a predefined area of the touch surface; and
output a signal indicating that the touch occurred within the predefined area of the touch surface.

2. The device of claim 1, wherein the front panel comprises a rigid material.

3. The device of claim 2, wherein the rigid material is one of metal, ceramic, plastic, glass, acrylic, Plexiglas, carbon fiber and fiberglass.

4. The device of claim 1, wherein the device comprises a plurality of vibration transducers including the first vibration transducer, the plurality of vibration transducers being mounted to the second surface of the front panel, and wherein the controller is electrically connected to the plurality of vibration transducers and is configured to:
receive a vibration signal from each of the plurality of vibration transducers, including the first vibration signal;
extract feature information corresponding to the predetermined features from one or more of the vibration signals; and
determine, based on the extracted feature information, that the touch occurred within the predefined area of the touch surface.

5. The device of claim 4, wherein the predetermined features include a minimum or a maximum signal value.

6. The device of claim 4, wherein the predetermined features include an energy contribution value corresponding to an energy contribution by frequencies below a predetermined frequency threshold.

7. The device of claim 6, wherein the predetermined frequency threshold is in a range of 50-150 Hz.

8. The device of claim 4, wherein the predetermined features include an energy contribution value corresponding to an energy contribution by frequencies above a predetermined frequency threshold.

9. The device of claim 8, wherein the predetermined frequency threshold is in a range of 50-150 Hz.

10. The device of claim 4, wherein the predetermined features include a maximum signal time corresponding to a time at which a vibration signal achieves a maximum signal value.

11. The device of claim 4, wherein the predetermined features include a minimum signal time corresponding to a time at which a vibration signal achieves a minimum signal value.

12. The device of claim 4, wherein the controller is further configured to:
store, frame by frame, the vibration signal from each of the plurality of vibration transducers;
determine that at least one of the vibration signals has crossed a noise floor threshold;
store, as one or more event signals, at least a portion of the vibration signal from each of the plurality of vibration transducers.

13. The device of claim 4, wherein the controller being configured to determine that the touch occurred within the predefined area of the touch sensitive device includes the controller being configured to:
generate a touch score for the predefined area based on the feature information using a classifier; and
determine, based on the touch score, whether the touch occurred within the predefined area of the touch surface.

14. The device of claim 4, wherein the controller being configured to determine that the touch occurred within the predefined area of the touch sensitive device includes the controller being configured to:
generate touch scores for a plurality of areas including the predefined area based on the feature information using a classifier; and
determine, based on analysis of all the touch scores, whether the touch occurred within the predefined area of the touch surface.

15. The device of claim 12, wherein the controller is implemented by a single processor.

16. The device of claim 12, wherein the controller is implemented by a plurality of sensor processors that each extract feature information from one or more of the plurality of vibration transducers and a classifier processor that receives the extracted feature information from the plurality of sensor processors to determine that the touch occurred within the predefined area of the touch surface.

17. The device of claim 1, wherein the vibration transducer comprises a microelectromechanical system (MEMS) microphone.

18. The device of claim 1, wherein the second surface is opposite the first surface.

19. The device of claim 4, wherein the second surface is opposite the first surface.

20. The device of claim 1, wherein the first surface and second surface are the same surface.

21. The device of claim 20, wherein the first vibration transducer is disposed in a bezel in the same surface.

22. The device of claim 4, wherein the first surface and second surface are the same surface, and wherein the plurality of vibration transducers are arranged around the predefined area.

23. A method for detecting touch by a controller, comprising:
receiving from a first vibration transducer of a touch sensitive device, a first vibration signal;
extracting feature information from the first vibration signal, the feature information corresponding to predetermined features;
determining, based on the feature information, that a touch has occurred within a predefined area on a touch surface of the touch sensitive device; and
outputting, by the controller, a signal indicating that the touch occurred within the predefined area.

24. The method of claim 23, further comprising:
receiving from a plurality of vibration transducers of the touch sensitive device, a plurality of vibration signals, each vibration signal corresponding to a respective vibration transducer, wherein the plurality of vibration transducers includes the first vibration transducer and the plurality of vibration signals includes the first vibration signal;
extracting feature information corresponding to the predetermined features from one or more of the plurality of vibration signals; and
determining, based on the extracted feature information, that the touch occurred within the predefined area.

25. The method of claim 24, wherein at least one of the plurality of vibration transducers comprises a microelectromechanical system (MEMS) microphone.

26. The method of claim 24, wherein the predetermined features include a minimum or a maximum signal amplitude.

27. The method of claim 24, wherein the predetermined features include an energy contribution value corresponding to an energy contribution by frequencies below a predetermined frequency threshold.

28. The method of claim 27, wherein the predetermined frequency threshold is in a range of 50-150 Hz.

29. The method of claim 24, wherein the predetermined features include an energy contribution value corresponding to an energy contribution by frequencies above a predetermined frequency threshold.

30. The method of claim 29, wherein the predetermined frequency threshold is in a range of 50-150 Hz.

31. The method of claim 24, wherein the predetermined features include a maximum signal time corresponding to a time at which a vibration signal achieves a maximum signal amplitude.

32. The method of claim 24, wherein the predetermined features include a minimum signal time corresponding to a time at which a vibration signal achieves a minimum signal amplitude.

33. The method of claim 24, further comprising:
storing, frame by frame, the vibration signal from each of the plurality of vibration transducers;
determining that at least one of the vibration signals has crossed a noise floor threshold;
storing, as one or more event signals, at least a portion of the vibration signal from each of the plurality of vibration transducers.

34. The method of claim 33, further comprising:
generating, by the controller, a touch score for the predefined area based on feature information using a classifier; and
determining, by the controller based on the touch score, that a touch occurred within the predefined area of the touch surface.

35. The method of claim 24, wherein the plurality of vibration transducers are disposed on a back surface of a metal panel, and receiving the plurality of vibration signals comprises receiving the vibration signals through the metal panel from a front surface of the metal panel.

36. A touch sensitive device, the device comprising:
a front panel having a touch surface and a back surface opposite the touch surface;
at least a first and a second vibration transducer mounted to the back surface adjacent to first and second predefined areas on the touch surface, respectively; and
a decoder electronically coupled to the first and second vibration transducers, the decoder configured to receive signals associated with the first and second vibration transducers, and to determine, based on the received signals, that a touch occurred within one of the first and second predefined areas of the touch surface; and
output a signal indicating that the touch occurred within the determined one of the first and second predefined areas of the touch surface.

37. The device of claim 36, wherein at least one of the first and second vibration transducers comprises a microelectromechanical system (MEMS) microphone.

38. The device of claim 36, wherein the signals associated with the first and second vibration transducers are generated by first and second comparators, respectively, and wherein the first and second comparators generate the signals by comparing outputs from the first and second vibration transducers to a threshold.

39. The device of claim 36, wherein the decoder determines that the touch occurred within one of the first and second predefined areas of the touch surface based on arrival times of the received signals at the decoder.
